(19) United States
(12) Patent Application Publication
(10) Pub. No.: US 2024/0212210 A1
(43) Pub. Date: Jun. 27, 2024

(54) HAND-EYE CALIBRATION METHOD BASED ON THREE-DIMENSIONAL POINT CLOUD OF CALIBRATION PLATE

(71) Applicant: GUANGDONG UNIVERSITY OF TECHNOLOGY, Guangzhou (CN)

(72) Inventors: Jian GAO, Guangzhou (CN); Zhenyu ZHENG, Guangzhou (CN); Zhuojun ZHENG, Guangzhou (CN); Lanyu ZHANG, Guangzhou (CN); Haixiang DENG, Guangzhou (CN); Xin CHEN, Guangzhou (CN)

(21) Appl. No.: 18/475,025

(22) Filed: Sep. 26, 2023

(30) Foreign Application Priority Data
Dec. 23, 2022 (CN) 202211665627.X

(51) Int. Cl. G06T 7/80; B25J 9/16; H04N 17/00

(52) U.S. Cl. CPC G06T 7/80; B25J 9/1692; B25J 9/1697; H04N 17/002; G06T 2207/10028; G06T 2207/30244

(57) ABSTRACT

A hand-eye calibration method based on three-dimensional point cloud of a calibration plate. The method includes: constructing a two-dimensional checkerboard calibration plate and a three-dimensional scanning system consisting of a camera and a projector; performing a calibration on each of the camera and the projector to obtain internal parameters of the two; performing a calibration on the camera and the projector to obtain a coordinate system transformation relation between the two; changing a pose of the calibration plate for at least three times, and acquiring at least three sets of transformation matrices of the calibration plate relative to a camera coordinate system and transformation matrices of an end of a manipulator relative to a manipulator base coordinate system through point cloud three-dimensional coordinates of the calibration plate; and solving to obtain a high-precision transformation matrix of the camera coordinate system relative to the manipulator base coordinate system.

### CROSS REFERENCE TO RELATED APPLICATIONS

This application claims foreign priority of Chinese Patent Application No. 202211665627. X, filed on Dec. 23, 2022 in the China National Intellectual Property Administration, the disclosures of all of which are hereby incorporated by reference.

### TECHNICAL FIELD

The present invention relates to the field of calibration technologies of pose transformation relation between manipulator and camera, and is particularly a hand-eye calibration method based on three-dimensional point cloud of a calibration plate.

### BACKGROUND OF THE PRESENT INVENTION

With the advent of the era of intelligent manufacturing, industrial manipulators have gradually replaced labors to be widely used in different industrial production fields, comprising aerospace, industrial production, logistics transportation and the like, and unmanned production has become a new development trend. The combination of a vision sensor and a manipulator has increasingly become a new industrial production mode, which greatly improves an automation level of industrial production. Hand-eye calibration needs to be performed on the vision sensor and the manipulator before a vision sensor-assisted manipulator is used in production, which means that a coordinate transformation relation between the vision sensor and the manipulator is established, so that the vision sensor provides guidance for the production operation of the manipulator.

The combination of the vision sensor (eye) and the manipulator (hand) constitutes a hand-eye system, and the hand-eye system may be divided into two types that the eye is arranged outside the hand (which means that an industrial camera is mounted on an outer portion of the manipulator) and the eye is arranged inside the hand (which means that the industrial camera is mounted at a tail end of the manipulator) according to different mounting modes of the vision sensor and the manipulator. Calibration principles of the two types of hand-eye systems both comprise establishing a transformation relation between a camera coordinate system and a manipulator coordinate system. It is usually necessary to establish the transformation relation between the camera coordinate system and the manipulator coordinate system with the help of a calibration plate during calibration, which means that an equation AX=XB is solved, wherein A represents a transformation matrix of the calibration plate relative to the camera coordinate system, B represents a transformation matrix of the tail end of the manipulator relative to the manipulator base coordinate system, and X is a transformation matrix between the camera coordinate system and the manipulator coordinate system to be solved. However, existing hand-eye calibration methods usually comprise estimating the transformation matrix A of the calibration plate relative to the camera coordinate system by a monocular camera. The solved transformation matrix may have large error fluctuation and low robustness, and an optimization model is not established after solving the transformation matrix X between the camera coordinate system and the manipulator coordinate system, so that the solution result precision is poor. Therefore, traditional hand-eye calibration methods have the defects of being low in robustness and poor in solution result precision, thus being difficult to apply the manipulator to a scene with a high positioning precision requirement.

### SUMMARY OF PRESENT INVENTION

Aiming at the above defects, the present invention provides a hand-eye calibration method based on three-dimensional point cloud of a calibration plate, which is intended to solve the problems that a traditional hand-eye calibration method is low in robustness, poor in solution result precision, and difficult to apply a manipulator to a scene with a high positioning precision requirement.

In order to achieve the object, the present invention adopts the following technical solution.

A hand-eye calibration method based on three-dimensional point cloud of a calibration plate comprises the following steps of:
step S1: constructing a two-dimensional checkerboard calibration plate and a three-dimensional scanning system, wherein the three-dimensional scanning system consists of a camera and a projector;
step S2: performing monocular calibration on the camera and the projector respectively by the two-dimensional checkerboard calibration plate to obtain internal parameters of the camera and the projector;
step S3: performing binocular calibration on the camera and the projector respectively by the two-dimensional checkerboard calibration plate to obtain a coordinate system transformation relation between the camera and the projector according to the internal parameters of the camera and the projector;
step S4: placing the two-dimensional checkerboard calibration plate at a tail end of a manipulator, and adjusting a pose of the two-dimensional checkerboard calibration plate to be in a common field of vision of the camera and the projector;
step S5: acquiring a transformation matrix A of the two-dimensional checkerboard calibration plate relative to a camera coordinate system through point cloud three-dimensional coordinates of the two-dimensional checkerboard calibration plate, and recording a transformation matrix B of the tail end of the manipulator relative to a manipulator base coordinate system at the same time;
step S6: changing the pose of the two-dimensional checkerboard calibration plate for at least three times, and repeating the above step S5 to obtain at least three sets of transformation matrices A of the two-dimensional checkerboard calibration plate relative to the camera coordinate system and transformation matrices B of the tail end of the manipulator relative to the manipulator base coordinate system;
step S7: establishing an equation set A₂⁻¹A₁X=XB₂⁻¹B₁ according to the fixed transformation relation between the two-dimensional checkerboard calibration plate and the tail end of the manipulator, wherein A₁ and B₁ represent a first set of transformation matrix A and transformation matrix B, and A₂ and B₂ represent a second set of transformation matrix A and transformation matrix B; and solving a transformation matrix X of the camera coordinate system relative to the manipulator base coordinate system by a quaternion method; and
step S8: taking [symbol] A₂⁻¹A₁X−XB₂⁻¹B₁ [symbol] , as a cost function to perform iterative solution by a least square method to obtain a transformation matrix X′ of the camera coordinate system relative to the manipulator base coordinate system with a precision range of 95 um to 105 um.

Preferably, the step S5 specifically comprises the following steps of:
step S51: shooting an image of the two-dimensional checkerboard calibration plate by the camera, and acquiring pixel coordinates (x, y)ₙ of each angular point in the two-dimensional checkerboard calibration plate, wherein n=0, 1, 2, 3 . . . S−1, S represents a total number of angular points of the checkerboard calibration plate, and n represents any angular point of the checkerboard calibration plate;
step S52: projecting N sinusoidal fringe patterns on the two-dimensional checkerboard calibration plate by the projector, triggering the camera to shoot the fringe patterns on a surface of the two-dimensional checkerboard calibration plate during projection, and dephasing fringes by a phase shift method to obtain point cloud three-dimensional coordinates (X, Y, Z); of each pixel point in the camera coordinate system, wherein i=H*W, H represents a height of a camera resolution, and W represents a width of the camera resolution;
step S53: taking pixel coordinates (x, y)ₙ of each angular point in the two-dimensional checkerboard calibration plate as an index, and acquiring point cloud three-dimensional coordinates (X, Y, Z)ₙ corresponding to each angular point in the two-dimensional checkerboard calibration plate from point cloud three-dimensional coordinates of all pixels in the camera coordinate system, wherein n=0, 1, 2, 3 . . . S−1, S represents the total number of the angular points of the checkerboard calibration plate, and n represents any angular point of the checkerboard calibration plate;
step S54: taking the point cloud three-dimensional coordinates of each angular point in the two-dimensional checkerboard calibration plate as a center, taking a three-dimensional square point cloud frame with a side length being a preset pixel value, and arithmetically averaging all point cloud three-dimensional coordinates in the three-dimensional square point cloud frame as real point cloud three-dimensional coordinates (X′, Y′, Z′)ₙ of each angular point in the two-dimensional checkerboard calibration plate, wherein n=0, 1, 2, 3 . . . S−1, S represents the total number of the angular points of the checkerboard calibration plate, and n represents any angular point of the checkerboard calibration plate; and
step S55: taking a first angular point in an upper left corner of the two-dimensional checkerboard calibration plate as an origin and an actual size of each checkerboard in the two-dimensional checkerboard calibration plate as the side length, and establishing a two-dimensional checkerboard calibration plate coordinate system to obtain three-dimensional coordinates (X″, Y″, Z″)ₙ of each angular point in the two-dimensional checkerboard calibration plate coordinate system, wherein n=0, 1, 2, 3 . . . S−1, S represents the total number of the angular points of the checkerboard calibration plate, and n represents any angular point of the checkerboard calibration plate; and obtaining the transformation matrix A of the two-dimensional checkerboard calibration plate relative to the camera coordinate system by an SVD decomposition method, and recording the transformation matrix B of the tail end of the manipulator relative to the manipulator base coordinate system at the same time.

Preferably, in the step S2, the internal parameters of the camera are:

$$[ \begin{matrix}fcx & 0 & uc 0 \\ 0 & fcy & vc 0 \\ 0 & 0 & 1\end{matrix} ]$$

wherein, fcx represents a number of pixels occupied by a focal length f of the camera in an x-axis direction of a camera internal image coordinate system, which is also called a normalized focal length in the x-axis direction, in a unit of pixel; fcy represents a number of pixels occupied by a focal length f of the camera in a y-axis direction of the camera internal image coordinate system, which is also called a normalized focal length in the y-axis direction, in a unit of pixel; and (uc0, vc0) represent an origin of the camera internal image coordinate system, which is namely an intersection of a camera optical axis and a camera imaging plane, in a unit of pixel;
the internal parameters of the projector are:

$$[ \begin{matrix}fpx & 0 & up 0 \\ 0 & fpy & vp 0 \\ 0 & 0 & 1\end{matrix} ]$$

wherein, fpx represents a number of pixels occupied by a focal length f of the projector in an x-axis direction of a DMD image coordinate system, which is also called a normalized focal length in the x-axis direction, in a unit of pixel; fpy represents a number of pixels occupied by a focal length f of the projector in a y-axis direction of the DMD image coordinate system, which is also called a normalized focal length in the y-axis direction, in a unit of pixel; and (up0, vp0) represent an origin of the DMD image coordinate system, which is namely an intersection of a projector optical axis and a projector imaging plane, in a unit of pixel.

Preferably, in the step S3, the coordinate system transformation relation between the camera and the projector is:

$$M = [ R \vert T ]$$

wherein, M is a matrix of 3*4, R is a matrix of 3*3, Tt is a matrix of 3*1, and R and T represent rotation transformation and translation transformation between the camera and the projector respectively.

Preferably, in the step S54, the point cloud three-dimensional coordinates (X, Y, Z)ₙ of each angular point in the two-dimensional checkerboard calibration plate are arithmetically averaged as the real point cloud three-dimensional coordinates (X′, Y′, Z′)ₙ of each angular point in the two-dimensional checkerboard calibration plate, and a specific calculation process is as follows:

$$\{ \begin{matrix}{X}^{′} = \frac{{\sum }_{j = 0}^{L * L} {X}_{j}}{L * L} \\ {Y}^{′} = \frac{{\sum }_{j = 0}^{L * L} {Y}_{j}}{L * L} \\ {Z}^{′} = \frac{{\sum }_{j = 0}^{L * L} {Z}_{j}}{L * L}\end{matrix}$$

wherein, L represents the side length of the three-dimensional square point cloud frame, j represents any point in the point cloud frame, j=0, 1, 2, 3 . . . L*L−1, Xⱼ represents an X-axis coordinate value of any point in the point cloud frame, Yⱼ represents a Y-axis coordinate value of any point in the point cloud frame, and Zⱼ represents a Z-axis coordinate value of any point in the point cloud frame.

Preferably, in the step S55, the transformation matrix of the two-dimensional checkerboard calibration plate relative to the camera coordinate system is:

$$A = [ \begin{matrix}{R}_{cam}^{cal} & {T}_{cam}^{cal} \\ 0 & 1\end{matrix} ]$$

wherein A is a matrix of 4*4, and R_{cam}^{cal} and cam are a matrix of 3*3 T_{cam}^{cal} and a matrix of 3*1 respectively, which sequentially represent rotation transformation and translation transformation of the two-dimensional checkerboard calibration plate relative to the camera coordinate system; and
the transformation matrix of the tail end of the manipulator relative to the manipulator base coordinate system is:

$$B = [ \begin{matrix}{R}_{base}^{end} & {T}_{base}^{end} \\ 0 & 1\end{matrix} ]$$

wherein B is a matrix of 4*4, and R_{base}^{end} and T_{base}^{end} are a matrix of 3*3 and a matrix of 3*1 respectively, which sequentially represent rotation transformation and translation transformation of the tail end of the manipulator relative to the manipulator base coordinate system.

Preferably, in the step S6, the transformation matrix A of each two-dimensional checkerboard calibration plate relative to the camera coordinate system corresponds to one transformation matrix B of the tail end of the manipulator relative to the manipulator base coordinate system, and a corresponding relation between the two transformation matrices is shown as follows:

$${[ \begin{matrix}A \\ B\end{matrix} ]}_{k}$$

wherein, k=0, 1, 2, 3 . . . I−1, I represents a total number of changed poses of the two-dimensional checkerboard calibration plate during hand-eye calibration, and k represents any one changed pose of the two-dimensional checkerboard calibration plate during hand-eye calibration.

Preferably, in the step S7, when a relation A₂⁻¹A₁X=XB₂⁻¹B₁ between two adjacent poses of the two-dimensional checkerboard calibration plate is established, k−1 relational expressions are obtained by k changed poses of the calibration plate, and an equation set is established as follows:

$$\{ \begin{matrix}{A}_{2}^{- 1} {A}_{1} X = {XB}_{2}^{- 1} {B}_{1} \\ {A}_{3}^{- 1} {A}_{2} X = {XB}_{3}^{- 1} {B}_{2} \\ ⋮ \\ {A}_{n}^{- 1} {A}_{n - 1} X = {XB}_{n}^{- 1} {B}_{n - 1}\end{matrix}$$

the equation set comprises k−1 equations in total, and then the transformation matrix of the camera coordinate system relative to the manipulator base coordinate system is solved by the quaternion method:

$$X = [ \begin{matrix}{R}_{base}^{cam} & {T}_{cam}^{end} \\ 0 & 1\end{matrix} ]$$

wherein X is a matrix of 4*4, and R_{base}^{cam} and T_{base}^{cam} are a matrix of 3*3 and a matrix of 3*1 respectively, which sequentially represent rotation transformation and translation transformation of the camera coordinate system relative to the manipulator base coordinate system.

Preferably, in the step S8, the cost function for solving the transformation matrix X′ of the camera coordinate system relative to the manipulator base coordinate system with the precision range of 95 um to 105 um is as follows:

$$min {\sum }_{k = 1}^{n - 1} {‖ {A}_{k + 1}^{- 1} {A}_{k} X - {XB}_{k + 1}^{- 1} {B}_{k} ‖}_{2}^{2}$$

wherein, k=0, 1, 2, 3 . . . I−1, I represents a total number of changed poses of the two-dimensional checkerboard calibration plate during hand-eye calibration, k represents any one changed pose of the two-dimensional checkerboard calibration plate during hand-eye calibration, the subscript 2 represents a 2-norm, and Aₖ and Bₖ represent a k^{th} set of transformation matrix A and transformation matrix B.

The technical solution provided by embodiments of the present application may comprise the following beneficial effects.

In the solution, the transformation matrix A of the two-dimensional checkerboard calibration plate relative to the camera coordinate system is acquired by the method of the point cloud three-dimensional coordinates of the two-dimensional checkerboard calibration plate, so that an error can be reduced and robustness can be improved, thus effectively solving the problems of poor precision and low stability of a traditional N-point perspective estimation method based on a monocular camera during calculation of the transformation matrix A. In the solution, the transformation matrix X′ with higher precision can be obtained by establishing the cost function and performing the iterative solution by the least square method. Therefore, compared with a traditional hand-eye calibration method, the solution is high in robustness, stable in effectiveness and high in solution result precision, thus being better applied to a scene with a high positioning precision requirement for the manipulator.

### DESCRIPTION OF THE DRAWINGS

FIG. 1 is flow chart of steps of a hand-eye calibration method based on three-dimensional point cloud of a calibration plate.

### DETAILED DESCRIPTION OF PREFERRED EMBODIMENTS

The implementations of the present invention are described in detail hereinafter. Examples of the implementations are shown in the accompanying drawings, wherein the same or similar reference numerals throughout the accompanying drawings denote the same or similar elements or elements having the same or similar functions. The embodiments described below by reference to the accompanying drawings are exemplary and are intended only to explain the present invention and are not to be construed as limiting the present invention.

A hand-eye calibration method based on three-dimensional point cloud of a calibration plate comprises the following steps of:
step S1: constructing a two-dimensional checkerboard calibration plate and a three-dimensional scanning system, wherein the three-dimensional scanning system consists of a camera and a projector;
step S2: performing monocular calibration on the camera and the projector respectively by the two-dimensional checkerboard calibration plate to obtain internal parameters of the camera and the projector;
step S3: performing binocular calibration on the camera and the projector respectively by the two-dimensional checkerboard calibration plate to obtain a coordinate system transformation relation between the camera and the projector according to the internal parameters of the camera and the projector;
step S4: placing the two-dimensional checkerboard calibration plate at a tail end of a manipulator, and adjusting a pose of the two-dimensional checkerboard calibration plate to be in a common field of vision of the camera and the projector;
step S5: acquiring a transformation matrix A of the two-dimensional checkerboard calibration plate relative to a camera coordinate system through point cloud three-dimensional coordinates of the two-dimensional checkerboard calibration plate, and recording a transformation matrix B of the tail end of the manipulator relative to a manipulator base coordinate system at the same time;
step S6: changing the pose of the two-dimensional checkerboard calibration plate for at least three times, and repeating the above step S5 to obtain at least three sets of transformation matrices A of the two-dimensional checkerboard calibration plate relative to the camera coordinate system and transformation matrices B of the tail end of the manipulator relative to the manipulator base coordinate system;
step S7: establishing an equation set A₂⁻¹A₁X=XB₂⁻¹B₁ according to the fixed transformation relation between the two-dimensional checkerboard calibration plate and the tail end of the manipulator, wherein A₁ and B₁ represent a first set of transformation matrix A and transformation matrix B, and A₂ and B₂ represent a second set of transformation matrix A and transformation matrix B; and solving a transformation matrix X of the camera coordinate system relative to the manipulator base coordinate system by a quaternion method; and
step S8: taking [symbol] A₂⁻¹A₁X−XB₂⁻¹B₁ [symbol] as a cost function to perform iterative solution by a least square method to obtain a transformation matrix X′ of the camera coordinate system relative to the manipulator base coordinate system with a precision range of 95 um to 105 um.

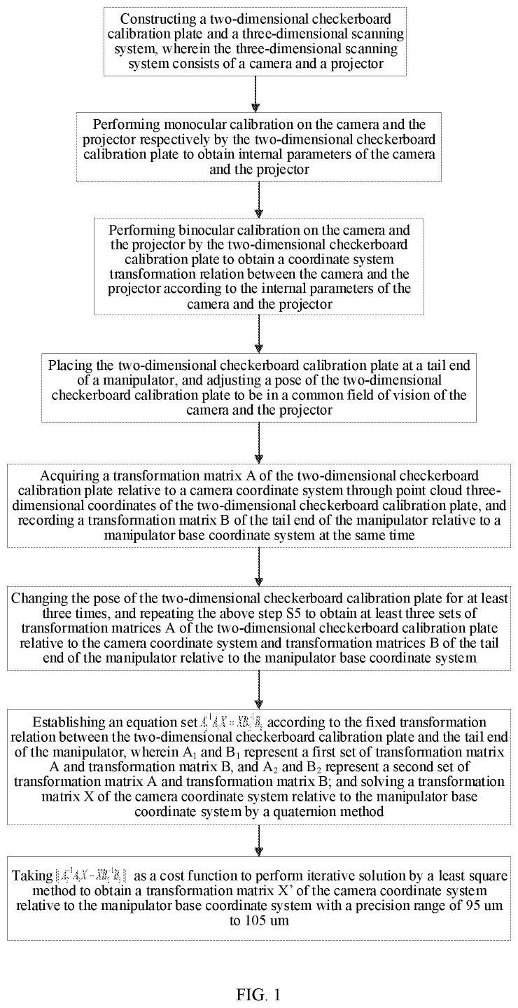

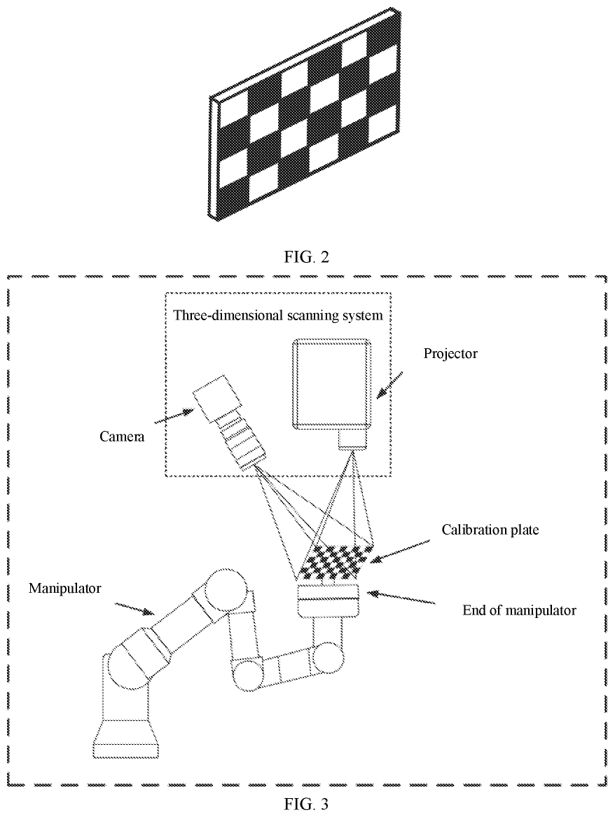

According to the hand-eye calibration method based on the three-dimensional point cloud of the calibration plate of the solution, as shown in FIG. 1, a traditional monocular camera is replaced by the three-dimensional scanning system consisting of the camera and the projector, and the three-dimensional scanning system can precisely acquire point cloud three-dimensional data of the two-dimensional checkerboard calibration plate. Specifically, the establishment of the three-dimensional scanning system comprises the following two steps. In the first step, the internal parameters of the camera and the projector are respectively calibrated by the two-dimensional checkerboard calibration plate, which means that the camera and the projector are monocularly calibrated respectively. The purpose of monocular calibration of the camera is to determine the internal parameters and distortion coefficients of the camera to correct image distortion caused by lens distortion, thus improving positioning precision of the three-dimensional scanning system. The purpose of monocular calibration of the projector is to determine the internal parameters and distortion coefficients of the projector according to the known internal parameters of the camera, thus improving three-dimensional reconstruction precision of an object to be measured. In the second step, a spatial transformation relation between a camera coordinate system and a projector coordinate system is calibrated by the two-dimensional checkerboard calibration plate respectively, which means that the camera and the projector are binocularly calibrated. The internal parameters of the camera and projector are respectively determined by monocularly calibrating the camera and the projector, but a pose transformation relation between the camera and the projector in space has not been determined. The pose transformation relation between the camera and the projector in space can be respectively effectively determined by binocularly calibrating the camera and the projector.

The calibration plate in the solution is the two-dimensional checkerboard calibration plate, while an existing calibration plate is a calibration plate with a circular pattern. In one embodiment, the two-dimensional checkerboard calibration plate is square, and the circular calibration plate takes a side length of the two-dimensional checkerboard calibration plate as a diameter. Comparing the two calibration plates, an area of the two-dimensional checkerboard calibration plate is larger than that of the circular calibration plate, so that more point cloud three-dimensional data can be obtained.

In the solution, when the transformation matrix A of the two-dimensional checkerboard calibration plate relative to the camera coordinate system is acquired, a traditional method of estimating the transformation matrix A of the two-dimensional checkerboard calibration plate relative to the camera coordinate system by N-point perspective based on a monocular camera is abandoned, and the method based on the point cloud three-dimensional coordinates of the two-dimensional checkerboard calibration plate is used to acquire the transformation matrix A of the two-dimensional checkerboard calibration plate relative to the camera coordinate system, thus effectively solving the problems of poor precision and low stability of the traditional N-point perspective estimation method based on the monocular camera during calculation of the transformation matrix A.

In the solution, point cloud three-dimensional information of the two-dimensional checkerboard calibration plate relative to the camera coordinate system may be precisely acquired by the three-dimensional scanning system consisting of the camera and the projector. After the transformation matrix X of the camera coordinate system relative to the manipulator base coordinate system is solved, an optimization step is added, which means that the transformation matrix X′ with higher precision can be obtained by establishing the cost function and performing the iterative solution by the least square method, and the precision obtained by the traditional hand-eye calibration method is 1 mm to 2 mm, while the precision obtained by the hand-eye calibration method provided by the present invention can reach 95 um to 105 um, so that the precision is improved by an order of magnitude compared with the precision of the traditional hand-eye calibration method.

In the solution, the transformation matrix A of the two-dimensional checkerboard calibration plate relative to the camera coordinate system is acquired by the method of the point cloud three-dimensional coordinates of the two-dimensional checkerboard calibration plate, so that an error can be reduced and robustness can be improved, thus effectively solving the problems of poor precision and low stability of a traditional N-point perspective estimation method based on a monocular camera during calculation of the transformation matrix A. In the solution, the transformation matrix X′ with higher precision can be obtained by establishing the cost function and performing the iterative solution by the least square method. Therefore, compared with a traditional hand-eye calibration method, the solution is high in robustness, stable in effectiveness and high in solution result precision, thus being better applied to a scene with a high positioning precision requirement for the manipulator.

Preferably, the step S5 specifically comprises the following steps of:
step S51: shooting an image of the two-dimensional checkerboard calibration plate by the camera, and acquiring pixel coordinates (x, y)ₙ of each angular point in the two-dimensional checkerboard calibration plate, wherein n=0, 1, 2, 3 . . . S−1, S represents a total number of angular points of the checkerboard calibration plate, and n represents any angular point of the checkerboard calibration plate;
step S52: projecting N sinusoidal fringe patterns on the two-dimensional checkerboard calibration plate by the projector, triggering the camera to shoot the fringe patterns on a surface of the two-dimensional checkerboard calibration plate during projection, and dephasing fringes by a phase shift method to obtain point cloud three-dimensional coordinates (X, Y, Z); of each pixel point in the camera coordinate system, wherein i=H*W, H represents a height of a camera resolution, and W represents a width of the camera resolution;
step S53: taking pixel coordinates (x, y)ₙ of each angular point in the two-dimensional checkerboard calibration plate as an index, and acquiring point cloud three-dimensional coordinates (X, Y, Z)ₙ corresponding to each angular point in the two-dimensional checkerboard calibration plate from point cloud three-dimensional coordinates of all pixels in the camera coordinate system, wherein n=0, 1, 2, 3 . . . S−1, S represents the total number of the angular points of the checkerboard calibration plate, and n represents any angular point of the checkerboard calibration plate;
step S54: taking the point cloud three-dimensional coordinates of each angular point in the two-dimensional checkerboard calibration plate as a center, taking a three-dimensional square point cloud frame with a side length being a preset pixel value, and arithmetically averaging all point cloud three-dimensional coordinates in the three-dimensional square point cloud frame as real point cloud three-dimensional coordinates (X′, Y′, Z′)ₙ of each angular point in the two-dimensional checkerboard calibration plate, wherein n=0, 1, 2, 3 . . . S−1, S represents the total number of the angular points of the checkerboard calibration plate, and n represents any angular point of the checkerboard calibration plate; and
step S55: taking a first angular point in an upper left corner of the two-dimensional checkerboard calibration plate as an origin and an actual size of each checkerboard in the two-dimensional checkerboard calibration plate as the side length, and establishing a two-dimensional checkerboard calibration plate coordinate system to obtain three-dimensional coordinates (X″, Y″, Z″)ₙ of each angular point in the two-dimensional checkerboard calibration plate coordinate system, wherein n=0, 1, 2, 3 . . . S−1, S represents the total number of the angular points of the checkerboard calibration plate, and n represents any angular point of the checkerboard calibration plate; and obtaining the transformation matrix A of the two-dimensional checkerboard calibration plate relative to the camera coordinate system by an SVD decomposition method, and recording the transformation matrix B of the tail end of the manipulator relative to the manipulator base coordinate system at the same time.

In the embodiment, the point cloud three-dimensional coordinates of each angular point in the two-dimensional checkerboard calibration plate are taken as the center, the three-dimensional square point cloud frame with a side length being 100 pixels is taken, and all point cloud three-dimensional coordinates in the three-dimensional square point cloud frame are arithmetically averaged as the real point cloud three-dimensional coordinates (X′, Y′, Z′)ₙ of each angular point in the two-dimensional checkerboard calibration plate, which can reduce an influence of random error during generation of the point cloud three-dimensional coordinates of each angular point in the two-dimensional checkerboard calibration plate, thus being a measure to improve hand-eye calibration result precision.

In one embodiment, the two-dimensional checkerboard calibration plate consists of 12×9 small square lattices (108 in total), and an actual size of each square lattice is 1 mm×1 mm.

In the solution, the SVD decomposition method is a singular value decomposition method, and because the three-dimensional coordinates (X″, Y″, Z″)ₙ of each angular point in the two-dimensional checkerboard calibration plate in the calibration plate coordinate system are known, and the three-dimensional coordinates (X′, Y′, Z′)ₙ of each angular point in the two-dimensional checkerboard calibration plate in the camera coordinate system are also known, the spatial transformation relation between the two-dimensional checkerboard calibration plate coordinate system and the camera coordinate system may be obtained by the singular value decomposition method. The singular value decomposition method can simplify data, remove noise and improve algorithm results.

In the solution, the point cloud three-dimensional coordinates of each angular point in the two-dimensional checkerboard calibration plate are all arithmetically averaged, thus eliminating an influence of random noise on hand-eye calibration results. Compared with the traditional N-point perspective estimation method based on the monocular camera, the method of the solution has higher robustness.

Preferably, in the step S2, the internal parameters of the camera are:

$$[ \begin{matrix}fcx & 0 & uc 0 \\ 0 & fcy & vc 0 \\ 0 & 0 & 1\end{matrix} ]$$

wherein, fcx represents a number of pixels occupied by a focal length f of the camera in an x-axis direction of a camera internal image coordinate system, which is also called a normalized focal length in the x-axis direction, in a unit of pixel; fcy represents a number of pixels occupied by a focal length f of the camera in a y-axis direction of the camera internal image coordinate system, which is also called a normalized focal length in the y-axis direction, in a unit of pixel; and (uc0, vc0) represent an origin of the camera internal image coordinate system, which is namely an intersection of a camera optical axis and a camera imaging plane, in a unit of pixel; the internal parameters of the projector are:

$$[ \begin{matrix}fpx & 0 & up 0 \\ 0 & fpy & vp 0 \\ 0 & 0 & 1\end{matrix} ]$$

wherein, fpx represents a number of pixels occupied by a focal length f of the projector in an x-axis direction of a DMD image coordinate system, which is also called a normalized focal length in the x-axis direction, in a unit of pixel; fpy represents a number of pixels occupied by a focal length f of the projector in a y-axis direction of the DMD image coordinate system, which is also called a normalized focal length in the y-axis direction, in a unit of pixel; and (up0, vp0) represent an origin of the DMD image coordinate system, which is namely an intersection of a projector optical axis and a projector imaging plane, in a unit of pixel.

In the embodiment, a preparation can be made for determining the spatial transformation relation between the camera coordinate system and the projector coordinate system by acquiring the internal parameters of the camera and the projector.

Preferably, in the step S3, the coordinate system transformation relation between the camera and the projector is:

$$M = [ R \vert T ]$$

wherein, M is a matrix of 3*4, R is a matrix of 3*3, Tt is a matrix of 3*1, and R and T represent rotation transformation and translation transformation between the camera and the projector respectively.

Beneficial effect: in the embodiment, it is beneficial for further determining the pose transformation relation between the camera coordinate system and the projector coordinate system in three-dimensional space by acquiring the coordinate system transformation relation between the camera and the projector.

Preferably, in the step S54, the point cloud three-dimensional coordinates (X, Y, Z)ₙ of each angular point in the two-dimensional checkerboard calibration plate are arithmetically averaged as the real point cloud three-dimensional coordinates (X′, Y′, Z′)ₙ of each angular point in the two-dimensional checkerboard calibration plate, and a specific calculation process is as follows:

$$\{ \begin{matrix}{X}^{′} = \frac{{\sum }_{j = 0}^{L * L} {X}_{j}}{L * L} \\ {Y}^{′} = \frac{{\sum }_{j = 0}^{L * L} {Y}_{j}}{L * L} \\ {Z}^{′} = \frac{{\sum }_{j = 0}^{L * L} {Z}_{j}}{L * L}\end{matrix}$$

wherein, L represents the side length of the three-dimensional square point cloud frame, j represents any point in the point cloud frame, j=0, 1, 2, 3 . . . L*L−1, Xⱼ represents an X-axis coordinate value of any point in the point cloud frame, Yⱼ represents a Y-axis coordinate value of any point in the point cloud frame, and Zⱼ represents a Z-axis coordinate value of any point in the point cloud frame.

In the embodiment, in the solution, the camera collects the fringe patterns, the point cloud three-dimensional coordinates (X, Y, Z)ₙ of each angular point in the two-dimensional checkerboard calibration plate are obtained via dephasing by the phase shift method, and the three-dimensional square point cloud frame with the side length being 100 pixels is taken to arithmetically average the point cloud three-dimensional coordinates (X, Y, Z), of each angular point, so that the point cloud three-dimensional coordinates (X′, Y′, Z′)ₙ of each angular point in the two-dimensional checkerboard calibration plate with high precision can be obtained.

Preferably, in the step S55, the transformation matrix of the two-dimensional checkerboard calibration plate relative to the camera coordinate system is:

$$A = [ \begin{matrix}{R}_{cam}^{cal} & {T}_{cam}^{cal} \\ 0 & 1\end{matrix} ]$$

wherein A is a matrix of 4*4, and R_{cam}^{cal} and T_{cam}^{cal} are a matrix of 3*3 and a matrix of 3*1 respectively, which sequentially represent rotation transformation and translation transformation of the two-dimensional checkerboard calibration plate relative to the camera coordinate system; and
the transformation matrix of the tail end of the manipulator relative to the manipulator base coordinate system is:

$$B = [ \begin{matrix}{R}_{base}^{end} & {T}_{base}^{end} \\ 0 & 1\end{matrix} ]$$

wherein B is a matrix of 4*4, and R_{base}^{end} and T_{cam}^{cal} and are a matrix of 3*3 and a matrix of 3*1 respectively, which sequentially represent rotation transformation and translation transformation of the tail end of the manipulator relative to the manipulator base coordinate system.

In the embodiment, the subsequent transformation matrix X of the camera coordinate system relative to the manipulator base coordinate system can be further obtained by obtaining the transformation matrix A of the two-dimensional checkerboard calibration plate relative to the camera coordinate system and the transformation matrix B of the tail end of the manipulator relative to the manipulator base coordinate system.

Preferably, in the step S6, the transformation matrix A of each two-dimensional checkerboard calibration plate relative to the camera coordinate system corresponds to one transformation matrix B of the tail end of the manipulator relative to the manipulator base coordinate system, and a corresponding relation between the two transformation matrices is shown as follows:

$${[ \begin{matrix}A \\ B\end{matrix} ]}_{k}$$

wherein, k=0, 1, 2, 3 . . . I−1, I represents a total number of changed poses of the two-dimensional checkerboard calibration plate during hand-eye calibration, and k represents any one changed pose of the two-dimensional checkerboard calibration plate during hand-eye calibration.

In the embodiment, one transformation matrix A and one corresponding transformation matrix B may be obtained at the same time when the two-dimensional checkerboard calibration plate moves by one pose each time, while the transformation matrix X obtained by hand-eye calibration needs to be solved by simultaneously combining multiple sets of transformation matrices A and transformation matrices B into the equation set. It is impossible to solve the X matrix only by one transformation matrix A and one transformation matrix B, and 30 sets of transformation matrices A and transformation matrices B are usually needed to solve the transformation matrix X, so that the two-dimensional checkerboard calibration plate needs to be changed for 30 times to obtain the multiple sets of transformation matrices A and transformation matrices B.

Preferably, in the step S7, when a relation A₂⁻¹A₁X=XB₂⁻¹B₁ between two adjacent poses of the two-dimensional checkerboard calibration plate is established, k−1 relational expressions are obtained by k changed poses of the calibration plate, and an equation set is established as follows:

$$\{ \begin{matrix}{A}_{2}^{- 1} {A}_{1} X = {XB}_{2}^{- 1} {B}_{1} \\ {A}_{3}^{- 1} {A}_{2} X = {XB}_{3}^{- 1} {B}_{2} \\ ⋮ \\ {A}_{n}^{- 1} {A}_{n - 1} X = {XB}_{n}^{- 1} {B}_{n - 1}\end{matrix}$$

the equation set comprises k−1 equations in total, and then the transformation matrix of the camera coordinate system relative to the manipulator base coordinate system is solved by the quaternion method:

$$X = [ \begin{matrix}{R}_{base}^{cam} & {T}_{base}^{cam} \\ 0 & 1\end{matrix} ]$$

wherein X is a matrix of 4*4, and R_{base}^{cam} and T_{base}^{cam} are a matrix of 3*3 and a matrix of 3*1 respectively, which sequentially represent rotation transformation and translation transformation of the camera coordinate system relative to the manipulator base coordinate system.

In the embodiment, the two-dimensional checkerboard calibration plate needs to be changed for many times to obtain the multiple sets of transformation matrices A and transformation matrices B. Specifically, according to the pose change of the two-dimensional checkerboard calibration plate, firstly, no matter how the two-dimensional checkerboard calibration plate is changed in pose, the two-dimensional checkerboard calibration plate should be in a common field of view of the camera and the projector, and secondly, the two-dimensional checkerboard calibration plate should be evenly changed in pose in the common field of view of the camera and the projector, and should not only move in a center of the field of view, and four corners of the field of view should also have pose changes. Moreover, two adjacent pose changes of the two-dimensional checkerboard calibration plate should satisfy that there are movements in all X, Y and Z directions and rotations around all X, Y and Z axes, which means that the pose changes of the two-dimensional checkerboard calibration plate are six-degree-of-freedom changes.

In the embodiment, the transformation matrix X of the camera coordinate system relative to the manipulator base coordinate system is solved by the quaternion method, so that a calculation speed can be faster and a calculation error can be smaller.

Preferably, in the step S8, the cost function for solving the transformation matrix X′ of the camera coordinate system relative to the manipulator base coordinate system with the precision range of 95 um to 105 um is as follows:

$$min {\sum }_{k = 1}^{n - 1} {‖ {A}_{k + 1}^{- 1} {A}_{k} X - {XB}_{k + 1}^{- 1} {B}_{k} ‖}_{2}^{2}$$

wherein, k=0, 1, 2, 3 . . . I−1, I represents a total number of changed poses of the two-dimensional checkerboard calibration plate during hand-eye calibration, k represents any one changed pose of the two-dimensional checkerboard calibration plate during hand-eye calibration, the subscript 2 represents a 2-norm, and A and B, represent a k″ set of transformation matrix A and transformation matrix B.

In the embodiment, the transformation matrix X′ obtained by establishing the cost function and performing the iterative solution by the least square method may have higher precision, so that the method can be better applied to a scene with a high positioning precision requirement for the manipulator.

In addition, various functional units in various embodiments of the present invention may be integrated in one processing unit, or various units may exist alone physically, or two or more units may be integrated in one module. The above integrated modules may be implemented in the form of hardware, or in the form of a software functional module. The integrated module may be stored in a computer-readable storage medium when being implemented in the form of a software functional module and sold or used as an independent product.

Although the embodiments of the present invention have been shown and described above, it may be understood that the above embodiments are exemplary and cannot be understood as limiting the present invention, and those of ordinary skills in the art may make changes, modifications, substitutions and variations to the above embodiments within the scope of the present invention.

1. A hand-eye calibration method based on three-dimensional point cloud of a calibration plate, comprising the following steps of:
step S1: constructing a two-dimensional checkerboard calibration plate and a three-dimensional scanning system, wherein the three-dimensional scanning system consists of a camera and a projector;
step S2: performing a calibration on each of the camera and the projector by the two-dimensional checkerboard calibration plate to obtain internal parameters of the camera and the projector;
step S3: performing a calibration on both the camera and the projector by the two-dimensional checkerboard calibration plate to obtain a coordinate system transformation relation between the camera and the projector according to the internal parameters of the camera and the projector;
step S4: placing the two-dimensional checkerboard calibration plate at an end of a manipulator, and adjusting a pose of the two-dimensional checkerboard calibration plate to be in a common field of vision of the camera and the projector;
step S5: acquiring a transformation matrix A of the two-dimensional checkerboard calibration plate relative to a camera coordinate system through point cloud three-dimensional coordinates of the two-dimensional checkerboard calibration plate, and recording a transformation matrix B of the end of the manipulator relative to a manipulator base coordinate system at the same time;
wherein, the step S5 specifically comprises the following steps of:
step S51: shooting an image of the two-dimensional checkerboard calibration plate by the camera, and acquiring pixel coordinates (x, y)ₙ of each angular point in the two-dimensional checkerboard calibration plate, wherein n=0, 1, 2, 3 . . . S−1, S represents a total number of angular points of the checkerboard calibration plate, and n represents any angular point of the checkerboard calibration plate;
step S52: projecting N sinusoidal fringe patterns on the two-dimensional checkerboard calibration plate by the projector, triggering the camera to shoot the fringe patterns on a surface of the two-dimensional checkerboard calibration plate during projection, and dephasing fringes by a phase shift method to obtain point cloud three-dimensional coordinates (X, Y, Z)ᵢ of each pixel point in the camera coordinate system, wherein i=H*W, H represents a height of a camera resolution, and W represents a width of the camera resolution;
step S53: taking pixel coordinates (x, y)ₙ of each angular point in the two-dimensional checkerboard calibration plate as an index, and acquiring point cloud three-dimensional coordinates (X, Y, Z)ₙ corresponding to each angular point in the two-dimensional checkerboard calibration plate from point cloud three-dimensional coordinates of all pixels in the camera coordinate system, wherein n=0, 1, 2, 3 . . . S−1, S represents the total number of the angular points of the checkerboard calibration plate, and n represents any angular point of the checkerboard calibration plate;
step S54: taking the point cloud three-dimensional coordinates of each angular point in the two-dimensional checkerboard calibration plate as a center, taking a three-dimensional square point cloud frame with a side length being a preset pixel value, and arithmetically averaging all point cloud three-dimensional coordinates in the three-dimensional square point cloud frame as real point cloud three-dimensional coordinates (X′, Y′, Z′)ₙ of each angular point in the two-dimensional checkerboard calibration plate, wherein n=0, 1, 2, 3 . . . S−1, S represents the total number of the angular points of the checkerboard calibration plate, and n represents any angular point of the checkerboard calibration plate; and
step S55: taking a first angular point in an upper left corner of the two-dimensional checkerboard calibration plate as an origin and an actual size of each checkerboard in the two-dimensional checkerboard calibration plate as the side length, and establishing a two-dimensional checkerboard calibration plate coordinate system to obtain three-dimensional coordinates (X″, Y″, Z″)ₙ of each angular point in the two-dimensional checkerboard calibration plate coordinate system, wherein n=0, 1, 2, 3 . . . S−1, S represents the total number of the angular points of the checkerboard calibration plate, and n represents any angular point of the checkerboard calibration plate; and obtaining the transformation matrix A of the two-dimensional checkerboard calibration plate relative to the camera coordinate system by a singular value decomposition (SVD) method, and recording the transformation matrix B of the end of the manipulator relative to the manipulator base coordinate system at the same time;
step S6: changing the pose of the two-dimensional checkerboard calibration plate for at least three times, and repeating the above step S5 to obtain at least three sets of transformation matrices A of the two-dimensional checkerboard calibration plate relative to the camera coordinate system and transformation matrices B of the end of the manipulator relative to the manipulator base coordinate system;
step S7: establishing an equation set A₂⁻¹A₁X=XB₂⁻¹B₁ according to the fixed transformation relation between the two-dimensional checkerboard calibration plate and the end of the manipulator, wherein A₁ and B₁ represent a first set of transformation matrix A and transformation matrix B, and A₂ and B₂ represent a second set of transformation matrix A and transformation matrix B; and solving a transformation matrix X of the camera coordinate system relative to the manipulator base coordinate system by a quaternion method; and
step S8: taking ∥A₂⁻¹A₁X−XB₂⁻¹B₁∥ as a cost function to perform iterative solution by a least square method to obtain a transformation matrix X′ of the camera coordinate system relative to the manipulator base coordinate system with a precision range of 95 um to 105 um.

2. The hand-eye calibration method based on the three-dimensional point cloud of the calibration plate according to claim 1, wherein in the step S2, the internal parameters of the camera are:
$$[ \begin{matrix}fcx & 0 & uc 0 \\ 0 & fcy & vc 0 \\ 0 & 0 & 1\end{matrix} ]$$
wherein, fcx represents a number of pixels occupied by a focal length f of the camera in an x-axis direction of a camera internal image coordinate system, which is also called a normalized focal length in the x-axis direction, in a unit of pixel; fcy represents a number of pixels occupied by a focal length f of the camera in a y-axis direction of the camera internal image coordinate system, which is also called a normalized focal length in the y-axis direction, in a unit of pixel; and (uc0, vc0) represent an origin of the camera internal image coordinate system, which is namely an intersection of a camera optical axis and a camera imaging plane, in a unit of pixel;
the internal parameters of the projector are:
$$[ \begin{matrix}fpx & 0 & up 0 \\ 0 & fpy & vp 0 \\ 0 & 0 & 1\end{matrix} ]$$
wherein, fpx represents a number of pixels occupied by a focal length f of the projector in an x-axis direction of a DMD image coordinate system, which is also called a normalized focal length in the x-axis direction, in a unit of pixel; fpy represents a number of pixels occupied by a focal length f of the projector in a y-axis direction of the DMD image coordinate system, which is also called a normalized focal length in the y-axis direction, in a unit of pixel; and (up0, vp0) represent an origin of the DMD image coordinate system, which is namely an intersection of a projector optical axis and a projector imaging plane, in a unit of pixel.

3. The hand-eye calibration method based on the three-dimensional point cloud of the calibration plate according to claim 1, wherein in the step S3, the coordinate system transformation relation between the camera and the projector is:
M=[R|T]
wherein, M is a matrix of 3*4, R is a matrix of 3*3, T is a matrix of 3*1, and R and T represent rotation transformation and translation transformation between the camera and the projector respectively.

4. The hand-eye calibration method based on the three-dimensional point cloud of the calibration plate according to claim 1, wherein in the step S54, the point cloud three-dimensional coordinates (X, Y, Z)ₙ of each angular point in the two-dimensional checkerboard calibration plate are arithmetically averaged as the real point cloud three-dimensional coordinates (X′, Y′, Z′)ₙ of each angular point in the two-dimensional checkerboard calibration plate, and a specific calculation process is as follows:
$$\{ \begin{matrix}{X}^{′} = \frac{{\sum }_{j = 0}^{L * L} {X}_{j}}{L * L} \\ {Y}^{′} = \frac{{\sum }_{j = 0}^{L * L} {Y}_{j}}{L * L} \\ {Z}^{′} = \frac{{\sum }_{j = 0}^{L * L} {Z}_{j}}{L * L}\end{matrix}$$
wherein, L represents the side length of the three-dimensional square point cloud frame, j represents any point in the point cloud frame, j=0, 1, 2, 3 . . . L*L−1, Xⱼ represents an X-axis coordinate value of any point in the point cloud frame, Yⱼ represents a Y-axis coordinate value of any point in the point cloud frame, and Zⱼ represents a Z-axis coordinate value of any point in the point cloud frame.

5. The hand-eye calibration method based on the three-dimensional point cloud of the calibration plate according to claim 1, wherein in the step S55, the transformation matrix of the two-dimensional checkerboard calibration plate relative to the camera coordinate system is:
$$A = [ \begin{matrix}{R}_{cam}^{cal} & {T}_{cam}^{cal} \\ 0 & 1\end{matrix} ]$$
wherein A is a matrix of 4*4, and R_{cam}^{cal} and T_{cam}^{cal} and a matrix of 3*3 and a matrix of 3*1 respectively, which sequentially represent rotation transformation and translation transformation of the two-dimensional checkerboard calibration plate relative to the camera coordinate system; and
the transformation matrix of the end of the manipulator relative to the manipulator base coordinate system is:
$$B = [ \begin{matrix}{R}_{base}^{end} & {T}_{base}^{end} \\ 0 & 1\end{matrix} ]$$
wherein B is a matrix of 4*4, and R_{base}^{end} and T_{base}^{end} are a matrix of 3*3 and a matrix of 3*1 respectively, which sequentially represent rotation transformation and translation transformation of the end of the manipulator relative to the manipulator base coordinate system.

6. The hand-eye calibration method based on the three-dimensional point cloud of the calibration plate according to claim 1, wherein in the step S6, the transformation matrix A of each two-dimensional checkerboard calibration plate relative to the camera coordinate system corresponds to one transformation matrix B of the end of the manipulator relative to the manipulator base coordinate system, and a corresponding relation between the two transformation matrices is shown as follows:
$${[ \begin{matrix}A \\ B\end{matrix} ]}_{k}$$
wherein, k−0, 1, 2, 3 . . . I−1, I represents a total number of changed poses of the two-dimensional checkerboard calibration plate during hand-eye calibration, and k represents any one changed pose of the two-dimensional checkerboard calibration plate during hand-eye calibration.

7. The hand-eye calibration method based on the three-dimensional point cloud of the calibration plate according to claim 1, wherein in the step S7, when a relation A₂⁻¹A₁X=XB₂⁻¹B₁ between two adjacent poses of the two-dimensional checkerboard calibration plate is established, k−1 relational expressions are obtained by k changed poses of the calibration plate, and an equation set is established as follows:
$$\{ \begin{matrix}{A}_{2}^{- 1} {A}_{1} X = {XB}_{2}^{- 1} {B}_{1} \\ {A}_{3}^{- 1} {A}_{2} X = {XB}_{3}^{- 1} {B}_{2} \\ ⋮ \\ {A}_{n}^{- 1} {A}_{n - 1} X = {XB}_{n}^{- 1} {B}_{n - 1}\end{matrix}$$
the equation set comprises k−1 equations in total, and then the transformation matrix of the camera coordinate system relative to the manipulator base coordinate system is solved by the quaternion method:
$$X = [ \begin{matrix}{R}_{base}^{cam} & {T}_{base}^{cam} \\ 0 & 1\end{matrix} ]$$
wherein X is a matrix of 4*4, and R_{base}^{cam} and T_{base}^{cam} are a matrix of 3*3 and a matrix of 3*1 respectively, which sequentially represent rotation transformation and translation transformation of the camera coordinate system relative to the manipulator base coordinate system.

8. The hand-eye calibration method based on the three-dimensional point cloud of the calibration plate according to claim 1, wherein in the step S8, the cost function for solving the transformation matrix X′ of the camera coordinate system relative to the manipulator base coordinate system with the precision range of 95 um to 105 um is as follows:
$$min {\sum }_{k = 1}^{n - 1} {‖ {A}_{k + 1}^{- 1} {A}_{k} X - {XB}_{k + 1}^{- 1} {B}_{k} ‖}_{2}^{2}$$
wherein, k=0, 1, 2, 3 . . . I−1, I represents a total number of changed poses of the two-dimensional checkerboard calibration plate during hand-eye calibration, k represents any one changed pose of the two-dimensional checkerboard calibration plate during hand-eye calibration, the subscript 2 represents a 2-norm, and Aₖ and Bₖ represent a k^{th} set of transformation matrix A and transformation matrix B.
